(19) United States
(12) Patent Application Publication
(10) Pub. No.: US 2019/0228721 A1
(43) Pub. Date: Jul. 25, 2019

(54) DISPLAY APPARATUS AND METHOD OF ADJUSTING BRIGHTNESS THEREOF

(71) Applicant: BOE TECHNOLOGY GROUP CO., LTD., Beijing (CN)

(72) Inventors: Zhicheng WANG, Beijing (CN); Xiaokang HAO, Beijing (CN)

(21) Appl. No.: 16/340,354

(22) PCT Filed: Jul. 27, 2018
(86) PCT No.: PCT/CN2018/097525

§ 371 Date: Apr. 8, 2019

(30) Foreign Application Priority Data
Aug. 10, 2017 (CN) 201710683475.9

(51) Int. Cl. G09G 3/34; G09G 5/10

(52) U.S. Cl. CPC G09G 3/3413; G09G 5/10; G09G 3/342

(57) ABSTRACT

A display apparatus includes a backlight source, a display panel, and a first backlight driver and a second backlight driver respectively coupled to the backlight source. The first backlight driver is further coupled to a pulse width modulation (PWM) signal generator, and is configured to drive the backlight source to emit light through a PWM signal output by the PWM signal generator, so that a brightness value of the display panel is within a first brightness range. The second backlight driver is further coupled to the PWM signal generator, and is configured to drive the backlight source to emit light through a PWM signal output by the PWM signal generator, so that the brightness value of the display panel is within a second brightness range.

This application claims priority to Chinese Patent Application No. 201710683475.9, filed on Aug. 10, 2017, titled “A DISPLAY DEVICE AND BRIGHTNESS ADJUSTING METHOD THEREOF”, which is incorporated herein by reference in its entirety.

### TECHNICAL FIELD

The present disclosure relates to the field of display technologies, and in particular, to a display apparatus and a method of adjusting brightness thereof.

### BACKGROUND

Display apparatuses are classified into active light-emitting type display apparatuses and passive light-emitting type display apparatuses. At the present stage, passive light-emitting type display apparatuses still dominate the market.

### SUMMARY

In an aspect, some embodiments of the present disclosure provide a display apparatus, which includes a backlight source, a display panel, and a first backlight driver and a second backlight driver respectively coupled to the backlight source. The first backlight driver is further coupled to a pulse width modulation (PWM) signal generator, and is configured to drive the backlight source to emit light through a PWM signal output by the PWM signal generator, so that a brightness value of the display panel is within a first brightness range. The second backlight driver is further coupled to the PWM signal generator, and is configured to drive the backlight source to emit light through a PWM signal output by the PWM signal generator, so that the brightness value of the display panel is within a second brightness range.

In some embodiments of the present disclosure, the first brightness range and the second brightness range partially overlap.

In some embodiments of the present disclosure, the first brightness range is a range from a first brightness value to a second brightness value, and the second brightness range is a range from a third brightness value to a fourth brightness value. The first brightness value is less than the second brightness value, the third brightness value is less than the fourth brightness value, the third brightness value is less than the first brightness value, and the fourth brightness value is greater than or equal to the first brightness value and less than the second brightness value.

In some embodiments of the present disclosure, the PWM signal generator and the first backlight driver are coupled by a first switch, and an on state of the first switch is controlled by a first enable signal. The PWM signal generator and the second backlight driver are coupled by a second switch, and an on state of the second switch is controlled by a second enable signal.

In some embodiments of the present disclosure, the display apparatus further includes a brightness detecting member and a controller. The brightness detecting member is disposed on a light exit side of the display panel, and is configured to detect the brightness value of the display panel. The controller is configured to compare the brightness value detected by the brightness detecting member with a preset threshold, wherein the preset threshold is greater than or equal to the first brightness value and less than or equal to the fourth brightness value. If the brightness value is less than or equal to the preset threshold, the controller outputs the second enable signal; otherwise, the controller outputs the first enable signal.

In some embodiments of the present disclosure, the display apparatus further includes a display driving main chip, and the controller and the PWM signal generator are integrated in the display driving main chip. The display driving main chip includes a PWM control port and an enable port. The PWM control port is coupled to the PWM signal generator, and the enable port is coupled to the controller. The first backlight driver and the second backlight driver are both coupled to the PWM control port and the enable port. The PWM signal generator outputs the PWM signal through the PWM control port; the controller outputs the first enable signal or the second enable signal by the enable port.

In some embodiments of the present disclosure, the brightness detecting member is disposed at an edge of a display area of the display panel close to a non-display area.

In some embodiments of the present disclosure, the brightness detecting member is a photosensitive device.

In some embodiments of the present disclosure, the backlight source includes LED strip(s).

In some embodiments of the present disclosure, the display apparatus further includes a backlight module, and the backlight source is disposed in the backlight module.

According to another aspect, some embodiments of the present disclosure provide a method of adjusting brightness of the display apparatus, which includes: driving, by the first backlight driver, the backlight source to emit light through the PWM signal, so that the brightness value of the display panel is within the first brightness range; and driving, by the second backlight driver, the backlight source to emit light through the PWM signal, so that the brightness value of the display panel is within the second brightness range.

In some embodiments of the present disclosure, the first brightness range and the second brightness range partially overlap.

In some embodiments of the present disclosure, the first brightness range is a range from a first brightness value to a second brightness value, and the second brightness range is a range from a third brightness value to a fourth brightness value. The first brightness value is less than the second brightness value, the third brightness value is less than the fourth brightness value, the third brightness value is less than the first brightness value, and the fourth brightness value is greater than or equal to the first brightness value and less than the second brightness value. At any time, only one of the first backlight driver and the second first backlight driver receives the PWM signal.

In some embodiments of the present disclosure, the step “driving, by the first backlight driver, the backlight source to emit light through the PWM signal” includes: receiving, by the first backlight driver, the PWM signal to drive the backlight source to emit light under control of a first enable signal; and the step “driving, by the second backlight driver, the backlight source to emit light through the PWM signal” includes: receiving, by the second backlight driver, the PWM signal to drive the backlight source to emit light under control of a second enable signal.

In some embodiments of the present disclosure, the method of adjusting brightness further includes: detecting, by a brightness detecting member, the brightness value of the display panel; and comparing, by a controller, the brightness value detected by the brightness detecting member with a preset threshold; outputting, by the controller, the second enable signal if the brightness value is less than or equal to the preset threshold; and outputting, by the controller, the first enable signal if the brightness value is greater than the preset threshold. The preset threshold is greater than or equal to the first brightness value and less than or equal to the fourth brightness value.

In some embodiments of the present disclosure, the third brightness value is less than or equal to 1 nit.

In some embodiments of the present disclosure, the second brightness value is greater than or equal to 600 nits.

In some embodiments of the present disclosure, the method of adjusting brightness further includes: driving, by the first backlight driver, the backlight source to emit light when the display apparatus is powered on, so that the brightness value of the display panel is within a range from the first brightness value to the second brightness value.

### BRIEF DESCRIPTION OF THE DRAWINGS

In order to describe technical solutions in embodiments of the present disclosure more clearly, the accompanying drawings used in the embodiments will be introduced briefly. Obviously, the accompanying drawings to be described below are merely some embodiments of the present disclosure, and a person of ordinary skill in the art can obtain other drawings according to these drawings without paying any creative effort.

FIG. 1 is a schematic diagram of a display apparatus and a coupling relationship thereof according to some embodiments of the present disclosure;

FIG. 2 is a schematic diagram of a coupling relationship among a first backlight driver, a second backlight driver, and a PWM signal generator according to some embodiments of the present disclosure;

FIG. 3 is a schematic diagram of another display apparatus and a coupling relationship thereof according to some embodiments of the present disclosure;

FIG. 4 is a schematic diagram of a coupling relationship among ports and components in a display apparatus according to some embodiments of the present disclosure; and

FIG. 5 is a schematic flow chart of a method of adjusting brightness of a display apparatus according to some embodiments of the present disclosure.

### DETAILED DESCRIPTION

The technical solutions in embodiments of the present disclosure will be described clearly and completely with reference to the accompanying drawings in embodiments of the present disclosure. Obviously, the described embodiments are merely some but not all of embodiments of the present disclosure. All other embodiments made on the basis of the embodiments of the present disclosure by a person of ordinary skill in the art without paying any creative effort shall be included in the protection scope of the present disclosure.

In the related art, brightness of passive light-emitting type display apparatuses is determined by brightness of a backlight source, and the brightness of the backlight source is adjusted through a pulse width modulation (PWM) signal. In practical applications, a minimum duty ratio of the PWM signal may only be set to 1%. Thus, a brightness of the display apparatus cannot be further decreased when adjusted to a certain extent, and thus may not meet requirements of use in certain special industries.

For example, for a display apparatus with a screen brightness of 600 nits, when a duty ratio of the PWM signal is 1%, the screen brightness can only be decreased to 10 nits and no further.

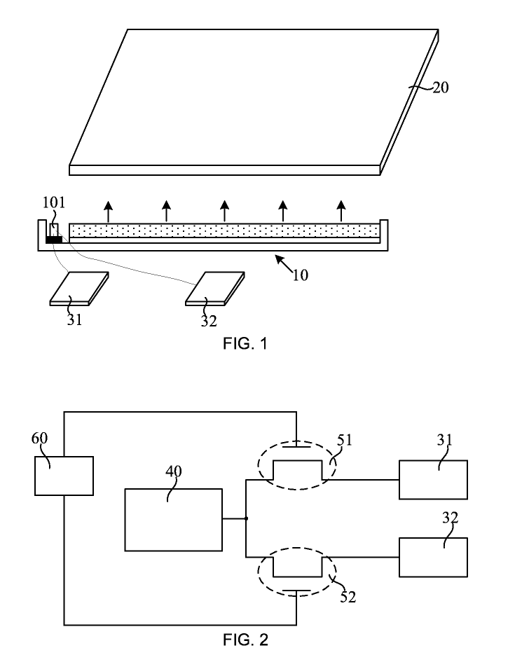

In view of the above problems, some embodiments of the present disclosure provide a display apparatus. As shown in FIG. 1, the display apparatus includes a backlight module 10, a display panel 20, a first backlight driver 31, and a second backlight driver 32. The backlight module 10 includes a backlight source 101. The first backlight driver 31 and the second backlight driver 32 are both coupled to the backlight source 101. The first backlight driver 31 is further coupled to a PWM signal generator, and is configured to drive the backlight source 101 to emit light through a PWM signal output by the PWM signal generator, so that a brightness value of the display panel 20 is within a range from a first brightness value to a second brightness value. The second backlight driver 32 is further coupled to the PWM signal generator, and is configured to drive the backlight source 101 to emit light through a PWM signal output by the PWM signal generator, so that the brightness value of the display panel 20 is within a range from a third brightness value to a fourth brightness value.

In some embodiments, a brightness range of the display panel 20 when driven by the first backlight driver 31 overlaps with a brightness range of the display panel 20 when driven by the second backlight driver 32. For example, the first brightness value is less than the second brightness value, the third brightness value is less than the fourth brightness value, the third brightness value is less than the first brightness value, and the fourth brightness value is greater than or equal to the first brightness value and less than the second brightness value.

In some embodiments, the PWM signal generator, the first backlight driver 31, and the second backlight driver 32 are all implemented in whole or in part by control drive circuit(s), for example, one or more application-specific integrated circuits (ASIC(s)).

It will be note that, although the first backlight driver 31 and the second backlight driver 32 are both coupled to the backlight source 101, only one backlight driver is needed to drive the backlight source 101 to emit light. Therefore, the first backlight driver 31 and the second backlight driver 32 do not drive the backlight source 101 at the same time.

In some embodiments, the first backlight driver 31 drives the backlight source 101. In this case, only the first backlight driver 31 receives the PWM signal, and the second backlight driver 32 does not receive the PWM signal, therefore the first backlight driver 31 drives the backlight source 101 to emit light. In some embodiments, the second backlight driver 32 drives the backlight source 101. In this case, only the second backlight driver 32 receives the PWM signal, and the first backlight driver 31 does not receive the PWM signal, therefore the second backlight driver 32 drives the backlight source 101 to emit light.

The PWM signal is described by taking an example in which the first backlight driver 31 drives the backlight source 101 to emit light. In some embodiments, the PWM signal is used to control a duration during which the first backlight driver 31 outputs current to the backlight source 101 in a single PWM signal period. In this case, an intensity of light emitted by the backlight 101 is determined by an average intensity of current output to the backlight 101. The average intensity of current is a product of a magnitude of the current output by the first backlight driver 31 and the duty ratio, and the duty ratio is a ratio of a duration of the current to the PWM signal period.

In some embodiments, when the second backlight driver 32 drives the backlight source 101 to emit light, the PWM signal is used to control a duration during which the second backlight driver 32 outputs current to the backlight source 101 in a single PWM signal period. The average intensity of current is a product of a magnitude of the current output by the second backlight driver 32 and the duty ratio, and the duty ratio is a ratio of the duration of the current to the PWM signal period.

In some embodiments, since the first backlight driver 31 and the second backlight driver 32 are both coupled to the backlight source 101, adjustable ranges of the duty ratios of the PWM signals received by the first backlight driver 31 and the second backlight driver 32 are the same. For example, in a case where the minimum duty ratio is 1%, an adjustable range of the duty ratio is 1%˜100%. In order for the first backlight driver 31 and the second backlight driver 32 to drive the backlight source 101 separately, and for the brightness value of the display panel to be within different brightness ranges, the first backlight driver 31 and the second backlight driver 32 output different currents.

The current output by the first backlight driver 31 enables the display panel to reach a maximum output brightness. The maximum output brightness is set, for example, according to actual needs. The current output by the second backlight driver 32 enables the display panel to reach a minimum output brightness. The minimum output brightness is set, for example, according to actual needs.

In some embodiments, the PWM signal generator is disposed in the display apparatus, so that the display apparatus displays independently. In some embodiments, the PWM signal generator is independent of the display apparatus.

In the display apparatus provided by the embodiments of the present disclosure, the first backlight driver 31 and the second backlight driver 32 may be arranged in a way that the second backlight driver 32 receives the PWM signal when the screen brightness is low, and the first backlight driver 31 receives the PWM signal when the screen brightness is high. Moreover, when the first backlight driver 31 drives the backlight source 101 to emit light, the brightness value of the display panel 20 is within a range from the first brightness value to the second brightness value. When the second backlight driver 32 drives the backlight source 101 to emit light, the brightness value of the display panel 20 is within a range from the third brightness value to the fourth brightness value. The fourth brightness value is greater than or equal to the first brightness value and less than the second brightness value. Therefore, the brightness may be adjusted within a range from the third brightness value to the second brightness value, widening an adjustable range of the brightness, and thereby meeting the requirements of special industries.

In some embodiments, as shown in FIG. 2, the PWM signal generator 40 and the first backlight driver 31 are coupled by a first switch 51, and an on state of the first switch 51 is controlled by a first enable signal. The PWM signal generator 40 and the second backlight driver 32 are coupled by a second switch 52, and an on state of the second switch 52 are controlled by a second enable signal.

For example, as shown in FIG. 2, gates of the first switch 51 and the second switch 52 are both coupled to an enable port 60. When a high level signal is output from the enable port 60, for example, to control the first switch 51 to be turned on, the PWM signal output by the PWM signal generator 40 is input to the first backlight driver 31. In this case, the second switch 52 receives the high level signal, and maintains an off state. On the contrary, when a low level signal is output from the enable port 60, for example, to control the second switch 52 to be turned on, the PWM signal output by the PWM signal generator 40 is input to the second backlight driver 32. In this case, the first switch 51 receives the low level signal, and maintains an off state.

By providing the first switch 51 between the PWM signal generator 40 and the first backlight driver 31, and providing the second switch 52 between the PWM signal generator 40 and the second backlight driver 32, enable signals may be able to turn on the first switch 51 or the second switch 52. This design is easy to implement and has a low cost.

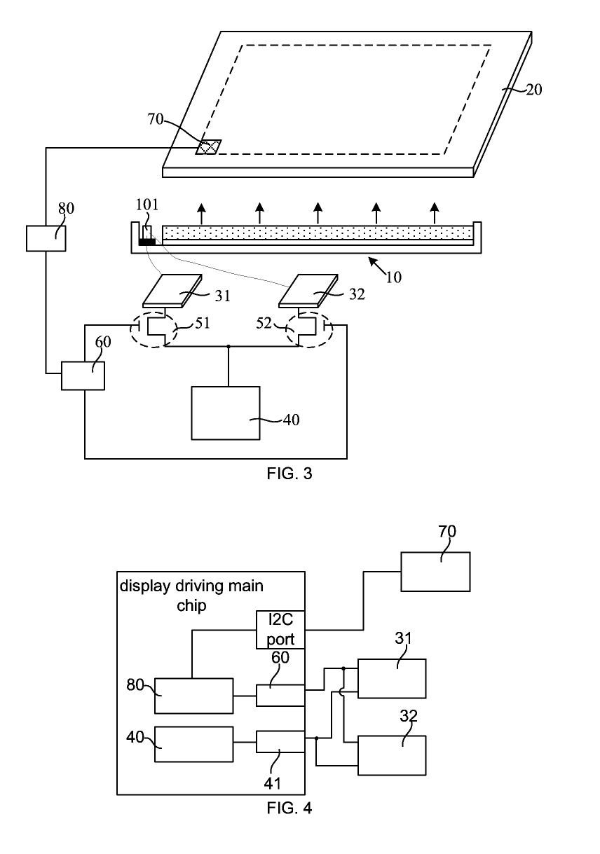

In some embodiments of the present disclosure, as shown in FIG. 3, the display apparatus further includes a brightness detecting member 70 and a controller 80. The brightness detecting member 70 is disposed on a light exit side of the display panel 20, and is configured to detect the brightness value of the display panel 20. The controller 80 is configured to compare the brightness value detected by the brightness detecting member 70 with a preset threshold, wherein the preset threshold is greater than or equal to the first brightness value and less than or equal to the fourth brightness value. If the brightness value is less than or equal to the preset threshold, the controller 80 outputs the second enable signal; otherwise, the controller 80 outputs the first enable signal.

Automatic switching of brightness ranges may be realized by using the brightness detecting member 70 to detect the brightness value of the display panel 20, and by using a controller 80 to compare the brightness value with a preset threshold and output the first enable signal or the second enable signal according to a comparative result, so as to control the first backlight driver 31 or the second backlight driver 32 to drive the backlight source 101.

In some embodiments, the brightness detecting member 70 is a photosensitive device. With this arrangement, the brightness detecting member may have better performance and low manufacturing cost.

In some embodiments, the controller 80 is implemented by microprocessor(s) programmed to perform the functions described herein. In some embodiments, the controller is implemented in whole or in part by specially configured hardware, for example, by one or more application-specific integrated circuits (ASIC(s)).

In some embodiments of the present disclosure, as shown in FIG. 4, the display apparatus further includes a display driving main chip. The controller 80 and the PWM signal generator 40 are integrated in the display driving main chip. The display driving main chip includes a PWM control port 41 and an enable port 60. The PWM control port 41 is coupled to the PWM signal generator 40, and the enable port 60 is coupled to the controller 80. The first backlight driver 31 and the second backlight driver 32 are both coupled to the PWM control port 41 and the enable port 60.

The PWM signal generator 40 outputs the PWM signal through the PWM control port 41, and the controller 80 outputs the first enable signal or the second enable signal through the enable port 60. By integrating the controller 80 and the PWM signal generator 40 in the display driving main chip, an integration level may be improved, which contributes to miniaturization and thinning of the display apparatus.

In some embodiments, as shown in FIG. 4, the brightness detecting member 70 is coupled to the controller 80 by an inter-integrated circuit (I2C) port.

In some embodiments of the present disclosure, as shown in FIG. 3, the brightness detecting member 70 is disposed at an edge of a display area of the display panel 20 close to a non-display area. In this way, an impact on display may be minimized.

In some embodiments, the backlight source 101 includes LED strip(s). With this arrangement, the backlight source may have the advantages of small size, low power consumption, and long service life.

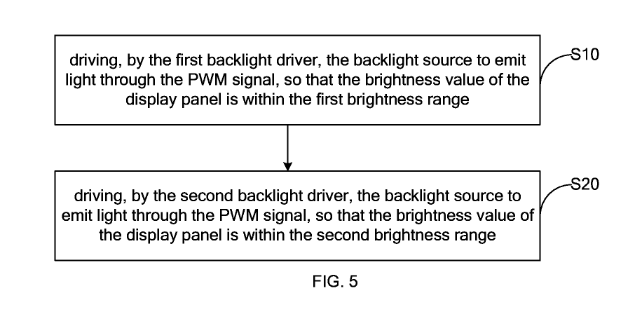

Some embodiments of the present disclosure further provide a method of adjusting brightness of a display apparatus. As shown in FIG. 5, the method includes step 10 (S10) and step 21 (S20). In some embodiments, the method is implemented by the display apparatus described above. The display apparatus is, for example, a liquid crystal display, a liquid crystal television, an organic electroluminescent display, an organic electroluminescent television, a digital photo frame, a mobile phone, a tablet computer, a digital photo frame, a navigator, or any other product or component having a display function. As for details of the following components, reference may be made to description of the components above, and they will not be described herein again.

In S10, the first backlight driver drives the backlight source to emit light through a PWM signal, so that the brightness value of the display panel is in a range from the first brightness value to the second brightness value.

In S20, the second backlight driver drives the backlight source to emit light through a PWM signal, so that the brightness value of the display panel is in a range from the third brightness value to the fourth brightness value.

In some embodiments, the brightness range of the display panel when driven by the first backlight driver overlaps with the brightness range of the display panel 20 when driven by the second backlight driver. For example, the third brightness value is less than the fourth brightness value, the third brightness value is less than the first brightness value, and the fourth brightness value is greater than or equal to the first brightness value and less than the second brightness value. At any time, only one of the first backlight driver and the second first backlight driver receives the PWM signal.

The description “at any time, only one of the first backlight driver and the second first backlight driver receives the PWM signal” means that: when the first backlight driver drives the backlight source, only the first backlight driver receives the PWM signal, and the second backlight driver does not receive the PWM signal. When the second backlight driver drives the backlight source, only the second backlight driver receives the PWM signals, and the first backlight driver does not receive the PWM signal.

It will be noted that, adjustable ranges of the duty ratios of the PWM signals received by the first backlight driver and the second backlight driver are the same. For example, in a case where the minimum duty ratio is 1%, an adjustable range of the duty ratio is 1%˜100%. Therefore, in order for the first backlight driver and the second backlight driver to drive the backlight source separately, and for the brightness value of the display panel to be within different brightness ranges, the first backlight driver and the second backlight driver output different currents.

In some embodiments of the present disclosure, the current output by the first backlight driver enables the display panel to reach the maximum output brightness. The maximum output brightness is set, for example, according to different requirements. The current output by the second backlight driver enables the display panel to reach the minimum output brightness. The minimum output brightness is set, for example, according to different requirements.

In addition, in some embodiments, the brightness range of the display panel when driven by the first backlight driver overlaps with the brightness range of the display panel 20 when driven by the second backlight driver.

In the method of adjusting brightness of the display apparatus provided by the embodiments of the present disclosure, when the first backlight driver receives the PWM signal to drive the backlight source to emit light, the brightness value of the display panel is kept to be within a range from the first brightness value to the second brightness value; however, when the second backlight driver receives the PWM signal to drive the backlight source to emit light, the brightness value of the display panel is kept to be within a range from the third brightness value to the fourth brightness value. Based on this, by setting the fourth brightness value to be greater than or equal to the first brightness value and less than the second brightness value, the brightness may be adjusted within a range from the third brightness value to the second brightness value. Therefore, the adjustable range of the brightness becomes wider, thereby meeting the requirements of special industries.

In some embodiments of the present disclosure, the step “in S10, the first backlight driver drives the backlight source to emit light through a PWM signal” includes: receiving, by the first backlight driver, the PWM signal to drive the backlight source to emit light under control of a first enable signal.

In some embodiments of the present disclosure, “in S20, the second backlight driver drives the backlight source to emit light through a PWM signal” includes: receiving, by the second backlight driver, the PWM signal to drive the backlight source to emit light under control of a second enable signal.

In some examples, the first enable signal is a high level signal, and the second enable signal is a low level signal. In some other examples, the first enable signal is a low level signal, and the second enable signal is a high level signal.

Controlling the first backlight driver or the second backlight driver to drive the backlight source to emit light by inputting an enable signal is easy to implement.

In some embodiments of the present disclosure, the method of adjusting brightness further includes: detecting, by a brightness detecting member, the brightness value of the display panel; comparing, by a controller, the brightness value detected by the brightness detecting member with a preset threshold; and outputting, by the controller, the second enable signal if the brightness value is less than or equal to the preset threshold, otherwise, outputting, by the controller, the first enable signal. The preset threshold is greater than or equal to the first brightness value and less than or equal to the fourth brightness value.

In a case where the preset threshold is equal to the first brightness value, if the display panel is supposed to output a brightness value less than the first brightness value, a detection error may occur in the brightness detecting member, and then the brightness value detected by the brightness detecting member may be greater than the preset threshold. As a result, it is not possible to switch from the first backlight driver to the second backlight driver, resulting in failure to meet user requirements.

Similarly, in a case where the preset threshold is equal to the fourth brightness value, if the display panel is supposed to output a brightness value greater than the fourth brightness value, a detection error may occur in the brightness detecting member, and then the brightness value detected by the brightness detecting member may be less than the preset threshold. As a result, it is not possible to switch from the second backlight driver to the first backlight driver, resulting in failure to meet user requirements.

Based on this, in some embodiments, the fourth brightness value is greater than the first brightness value and less than the second brightness value, and the preset threshold is greater than the first brightness value and less than the fourth brightness value.

In some embodiments, the preset threshold is set to be in an intermediate range between the first brightness value and the fourth brightness value. For example, in a case where the first brightness value is 50 nits and the fourth brightness value is 100 nits, the preset threshold is set between 70-80 nits.

Automatic switching of brightness ranges may be realized by using the brightness detecting member to detect the brightness value of the display panel, and by using a controller to compare the brightness value with a preset threshold and output the first enable signal or the second enable signal according to a comparative result, so as to control the first backlight driver or the second backlight driver to drive the backlight source.

In some embodiments, the third brightness value is less than or equal to 1 nit.

For example, the third brightness value is 0.1 nits, 0.17 nits, 0.2 nits, 0.25 nits, 0.3 nits, 0.35 nits, 0.4 nits, 0.5 nits, 0.6 nits, 0.7 nits, 0.8 nits, or 0.9 nits. By setting the third brightness value to be less than or equal to 1 nit, special requirements (for example, of the military industry) may be met. Based on this, in some embodiments, the fourth brightness value is greater than or equal to 100 nits.

In some embodiments, the second brightness value is greater than or equal to 600 nits. In this way, ordinary requirements and even requirements for high screen brightness may be met.

Based on this, in some embodiments, the first brightness value is greater than or equal to 50 nits.

Based on the above, in some embodiments, the method of adjusting brightness further includes: driving, by the first backlight driver, the backlight source to emit light when the display apparatus is powered on, so that the brightness value of the display panel is within a range from the first brightness value to the second brightness value.

Since the display apparatus is generally in a normal application environment when being powered on, the first backlight driver is set by default to drive the backlight light to emit light.

The foregoing descriptions are merely some implementation manners of the present disclosure, but the protection scope of the present disclosure is not limited thereto. Any person skilled in the art could readily conceive of changes or replacements within the technical scope of the present disclosure, which shall all be included in the protection scope of the present disclosure. Therefore, the protection scope of the present disclosure shall be subject to the protection scope of the claims.

1. A display apparatus, comprising a backlight source, a display panel, and a first backlight driver and a second backlight driver respectively coupled to the backlight source, wherein
the first backlight driver is further coupled to a pulse width modulation (PWM) signal generator, and is configured to drive the backlight source to emit light through a PWM signal output by the PWM signal generator, so that a brightness value of the display panel is within a first brightness range; and
the second backlight driver is further coupled to the PWM signal generator, and is configured to drive the backlight source to emit light through a PWM signal output by the PWM signal generator, so that the brightness value of the display panel is within a second brightness range.

2. The display apparatus according to claim 1, wherein the first brightness range and the second brightness range partially overlap.

3. The display apparatus according to claim 2, wherein the first brightness range is a range from a first brightness value to a second brightness value, the second brightness range is a range from a third brightness value to a fourth brightness value; the first brightness value is less than the second brightness value, the third brightness value is less than the fourth brightness value, the third brightness value is less than the first brightness value, and the fourth brightness value is greater than or equal to the first brightness value and less than the second brightness value.

4. The display apparatus according to claim 3, wherein the PWM signal generator and the first backlight driver are coupled by a first switch, and an on state of the first switch is controlled by using a first enable signal; and
the PWM signal generator and the second backlight driver are coupled by a second switch, and an on state of the second switch is controlled by using a second enable signal.

5. The display apparatus according to claim 4, further comprising:
a brightness detecting member disposed on a light exit side of the display panel, wherein the brightness detecting member is configured to detect the brightness value of the display panel; and
a controller configured to:
compare the brightness value detected by the brightness detecting member with a preset threshold, wherein the preset threshold is greater than or equal to the first brightness value and less than or equal to the fourth brightness value;
output the second enable signal if the brightness value is less than or equal to the preset threshold; and
output the first enable signal if the brightness value is greater than the preset threshold.

6. The display apparatus according to claim 5, further comprising a display driving main chip, wherein the controller and the PWM signal generator are integrated in the display driving main chip, and the display driving main chip comprises a PWM control port and an enable port;
the PWM control port is coupled to the PWM signal generator, the enable port is coupled to the controller; the first backlight driver and the second backlight driver are both coupled to the PWM control port and the enable port;
the PWM signal generator is configured to output the PWM signal through the PWM control port; the controller is configured to output the first enable signal or the second enable signal through the enable port.

7. The display apparatus according to claim 5, wherein the brightness detecting member is disposed at an edge of a display area of the display panel close to a non-display area.

8. The display apparatus according to claim 5, wherein the brightness detecting member is a photosensitive device.

9. The display apparatus according to claim 1, wherein the backlight source comprises LED strip(s).

10. The display apparatus according to claim 3, further comprising a backlight module, wherein the backlight source is disposed in the backlight module.

11. A method of adjusting brightness of the display apparatus according to claim 1, comprising:
driving, by the first backlight driver, the backlight source to emit light through the PWM signal, so that the brightness value of the display panel is within the first brightness range; and
driving, by the second backlight driver, the backlight source to emit light through the PWM signal, so that the brightness value of the display panel is within the second brightness range.

12. The method of adjusting brightness according to claim 11, wherein the first brightness range and the second brightness range partially overlap.

13. The method of adjusting brightness according to claim 12, wherein the first brightness range is a range from a first brightness value to a second brightness value, the second brightness range is a range from a third brightness value to a fourth brightness value; the first brightness value is less than the second brightness value, the third brightness value is less than the fourth brightness value, the third brightness value is less than the first brightness value, and the fourth brightness value is greater than or equal to the first brightness value and less than the second brightness value; and
at any time, only one of the first backlight driver and the second first backlight driver receives the PWM signal.

14. The method of adjusting brightness according to claim 13, wherein driving, by the first backlight driver, the backlight source to emit light through the PWM signal, comprises: receiving, by the first backlight driver, the PWM signal to drive the backlight source to emit light under control of a first enable signal; and
driving, by the second backlight driver, the backlight source to emit light through the PWM signal, comprises: receiving, by the second backlight driver, the PWM signal to drive the backlight source to emit light under control of a second enable signal.

15. The method of adjusting brightness according to claim 14, further comprising:
detecting, by a brightness detecting member, the brightness value of the display panel; and
comparing, by a controller, the brightness value detected by the brightness detecting member with a preset threshold; outputting, by the controller, the second enable signal if the brightness value is less than or equal to the preset threshold; and outputting, by the controller, the first enable signal if the brightness value is greater than the preset threshold, wherein
the preset threshold is greater than or equal to the first brightness value and less than or equal to the fourth brightness value.

16. The method of adjusting brightness according to claim 13, wherein the third brightness value is less than or equal to 1 nit.

17. The method of adjusting brightness according to claim 16, wherein the second brightness value is greater than or equal to 600 nits.

18. The method of adjusting brightness according to claim 13, further comprising: driving, by the first backlight driver, the backlight source to emit light when the display apparatus is powered on, so that the brightness value of the display panel is within a range from the first brightness value to the second brightness value.
